(19) United States
(12) Patent Application Publication
(10) Pub. No.: US 2013/0209686 A1
(43) Pub. Date: Aug. 15, 2013

(54) COATING OR CLADDING AND METHOD OF PREPARING SAME

(71) Applicants: RAMI ROTENBERG, KIRYAT ONO (IL); URIEL ROTENBERG, KIRYAT ONO (IL)

(72) Inventors: RAMI ROTENBERG, KIRYAT ONO (IL); URIEL ROTENBERG, KIRYAT ONO (IL)

(21) Appl. No.: 13/719,280

(22) Filed: Dec. 19, 2012

Related U.S. Application Data
(62) Division of application No. 12/445,738, filed on Apr. 16, 2009, now abandoned.

(30) Foreign Application Priority Data
Oct. 17, 2006 (IL) 178698

(51) Int. Cl. B05D 3/12

(52) U.S. Cl. CPC B05D 3/12
USPC 427/257

(57) ABSTRACT

A coating for a substrate, the coating including an acrylic adhesive adapted to be spread on the substrate and cured to form a decorative coating, and a method for providing a coated substrate, the method including spreading a layer of an acrylic adhesive on a substrate; and curing the acrylic adhesive to provide a coating affixed to the substrate.

### RELATED APPLICATIONS

This patent application is a divisional application of U.S. patent application Ser. No. 12/445,738, filed 16 Apr. 2009, and claims the benefit of priority from PCT Patent Application No. PCT/IL2007/001246, filed on Oct. 17, 2007, and Israel Patent application no. 178698, filed Oct. 17, 2006, the contents of which are incorporated herein by reference.

### FIELD OF THE INVENTION

The present invention relates to coatings and claddings, in general and, in particular, to decorative coatings and claddings for building walls and decorative articles.

### BACKGROUND OF THE INVENTION

Various types of coatings (layers of a substance spread over a surface for protection or decoration) and other covering layers are well known in the art for walls and ceilings of buildings and other structures. These include plaster and paint, stucco, and various types of cladding (protective or insulating layers fixed to the outside of a building or another structure), such as heavy stone or marble tiles which are affixed to the outer walls of buildings.

Murals and wall paintings at present are painted on concrete or wooden walls of buildings. The paintings must be prepared and executed in situ and their finish depends on the substrate on which the paint is applied and the number of layers of paint applied. After many years, certain types of paintings develop fine cracks, which add texture having the appearance of an old “Fresco” painting.

Acrylic adhesives are known in the market and are used to affix ceramic, porcelain, marble and mosaic tiles in place, as on concrete walls and floors.

### SUMMARY OF THE INVENTION

There is provided according to the present invention a coating for a substrate, the coating including an acrylic adhesive for spreading on the substrate. Preferably, the adhesive is a water-based acrylic adhesive.

According to one embodiment of the invention, the coating further includes an acrylic lacquer protective outer layer.

According to one embodiment of the invention, the coating further includes at least one pigment mixed into the adhesive before spreading.

According to an alternative embodiment of the invention, the coating further includes a paint layer applied to the cured adhesive.

Further according to a preferred embodiment, the coating further includes a plurality of cracks automatically created in the upper surface of the coating during and by curing.

There is further provided according to the invention a method for providing a coated substrate, the method including spreading a layer of an acrylic adhesive on a substrate, and curing the acrylic adhesive to provide a coating for the substrate. The coated substrate can serve as cladding for a building or structure.

According to one embodiment of the invention, the method further includes sponging an outer surface of the adhesive with a wet sponge during curing, so as to cause formation of a plurality of surface cracks.

If desired, one or more pigments can be incorporated in the adhesive before spreading, and/or the surface of the cured adhesive can be painted, drawn or printed upon.

### BRIEF DESCRIPTION OF THE DRAWINGS

The present invention will be further understood and appreciated from the following detailed description taken in conjunction with the drawings in which:

FIG. 1 is a schematic perspective sectional illustration of a substrate with a coating constructed and operative in accordance with one embodiment of the present invention;

FIG. 2 is an illustration of a substrate with a decorative coating according to another embodiment of the invention mounted as a table top;

FIG. 3 is an illustration of a decorative frame with a decorative coating according to the invention;

FIG. 4 is an illustration of a table with side panels having a decorative coating according to the invention;

FIG. 5 is an illustration of a mural with a decorative coating according to the invention;

FIG. 6 is an illustration of a substrate with a coating according to another embodiment of the invention;

FIG. 7 is an exploded view of cladding, according to one embodiment of the invention; and

FIG. 8 is a schematic perspective view of a tile according to another embodiment of the invention.

### DETAILED DESCRIPTION OF THE INVENTION

The present invention relates to a coating for a substrate and a method for coating a substrate therewith. The coating of the present invention includes an acrylic adhesive, preferably a water based acrylic adhesive, most preferably an x-linked acrylic adhesive having self-cross linked polymer binder, for example, “Seramic” and “Seramic TA” of Tambour Group, Israel, and “Sealix” (a professional trade-quality acrylic adhesive) of Nirlat Ltd., Israel, and “Keramic Bond” marketed by Denber Paints & Coatings Israel Ltd., Ofakim, Israel. The acrylic adhesive is adapted to be spread on a substrate and cured at room temperature and, preferably, a water-based protective outer layer is applied to the surface of the cured adhesive. The outer layer can be, for example, clear acrylic varnish or lacquer. This varnish may be car or airplane lacquer, or any other suitable varnish. Alternatively, an outer layer of clear polyurea, polyurethane, epoxy or similar material may be applied. This adhesive, when cured, provides superior strength (i.e., cannot easily be broken or cut), and substantially complete protection against moisture, as well as electrical insulation. According to certain embodiments of the invention, the coated substrate is fire resistant. The coating may be provided on a wall, lattice, object, panel or other substrate, and the coated substrate may be used as cladding for a wall or ceiling of an existing structure.

The coating may also include at least one pigment mixed into the adhesive before spreading, so as to provide a colored coating. Alternatively, or in addition, a layer of paint defining a decorative picture, may be applied to the cured adhesive, or the coated substrate can be printed upon in conventional printing machines for printing on rigid materials. The cured coating can also be drawn upon.

It will be appreciated that other additives can be added to the adhesive before curing, alternatively, or in addition to pigments. These additives can be selected so as to impart additional desired characteristics to the finished product. For example, mineral wool fibers (e.g., basalt insulation fibers) can be added to the adhesive for improved erosion resistance for use of the product as floor tiles.

According to a preferred embodiment of the invention, the coating defines a plurality of surface cracks, which are automatically created during and by the curing process. This process is initiated by rubbing wet sponges over the surface of the adhesive at the start of the curing process and curing the coating at room temperature for about 24 hours, before curing at higher temperatures.

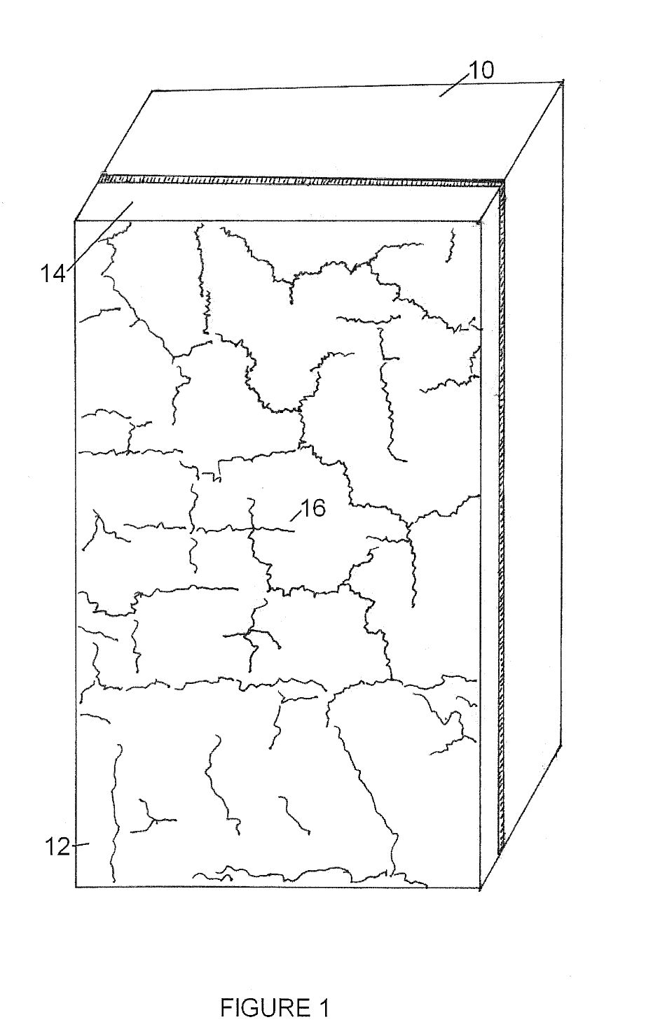

Referring now to FIG. 1, there is shown a schematic perspective sectional illustration of a substrate 10 with a coating 12 constructed and operative in accordance with one embodiment of the present invention. Substrate 10 can be any suitable substrate to which the coating 12 will bond, including, but not limited to, a screen or other lattice, wood, Styrofoam, aluminum, plasterboard, glass, plastic, ceramic, basalt insulation material, etc. The substrate can be flat or curved, large or small. Preferably, areas of up to about 3 meters can be coated at a time. After curing, an outer protective layer 14 is preferably provided to protect the coating and provide additional water resistance. This outer coating may be of polyurea, polyurethane, epoxy, clear lacquer, or any other suitable material. As can be seen, a series of cracks 16 have formed in the coating 12, providing a marbled or old-fashioned effect. It will be appreciated that the coated substrate can be a relatively light-weight panel which can be mounted on or coupled to an interior or exterior wall of a building, or used as a portion of a table, framed in a picture frame, etc., or can be a wall or ceiling of a building or structure.

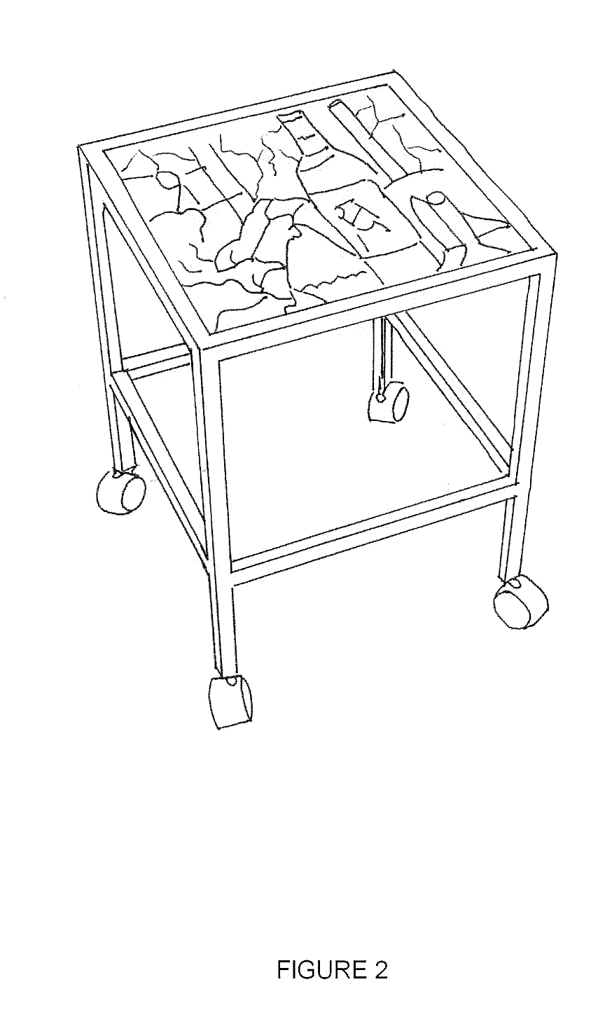

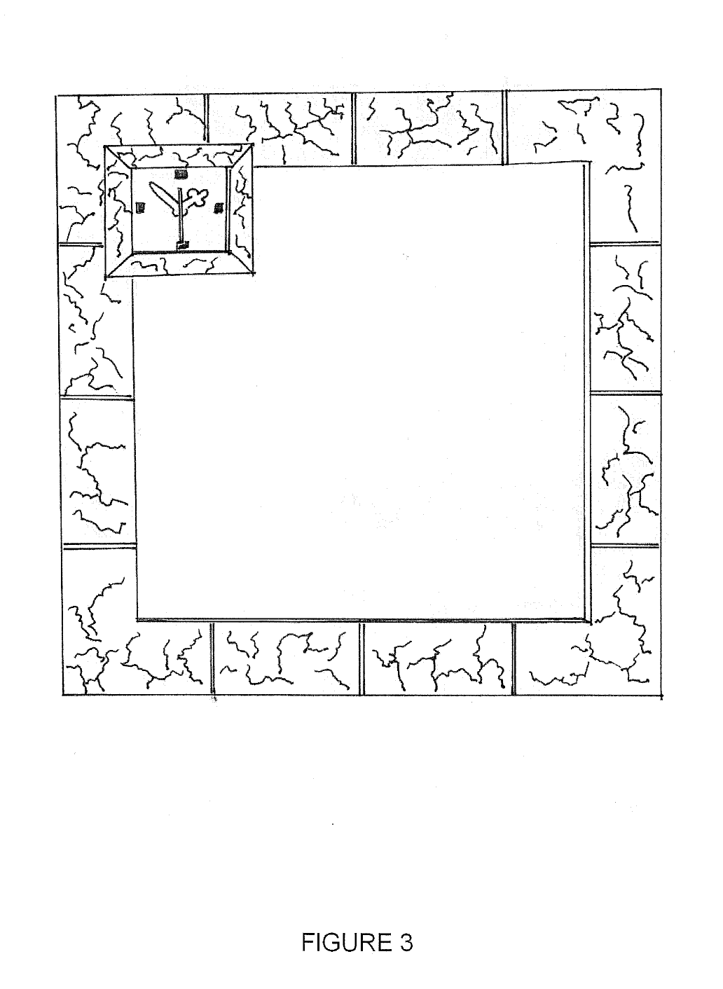

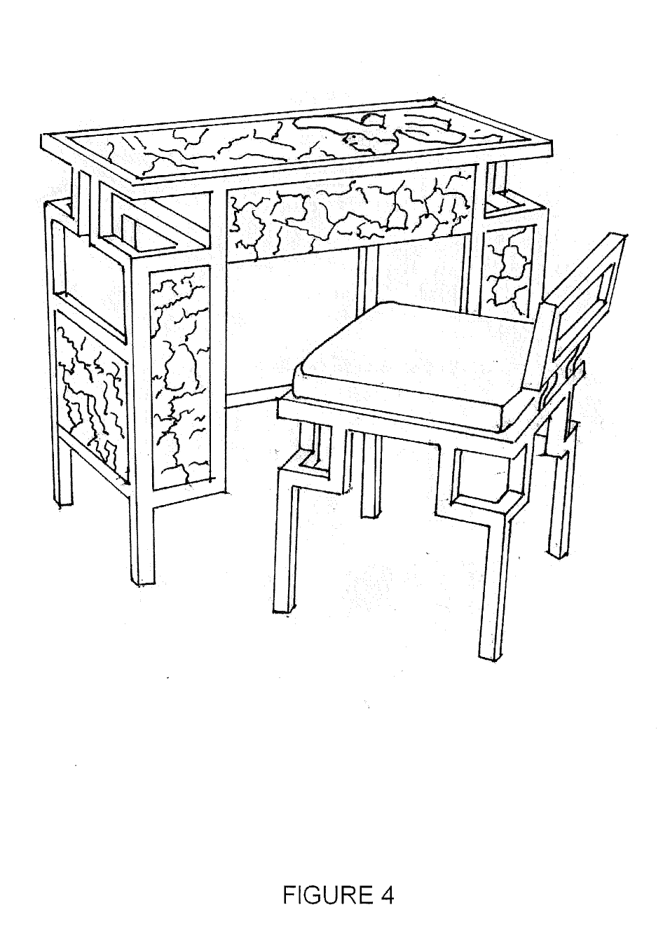

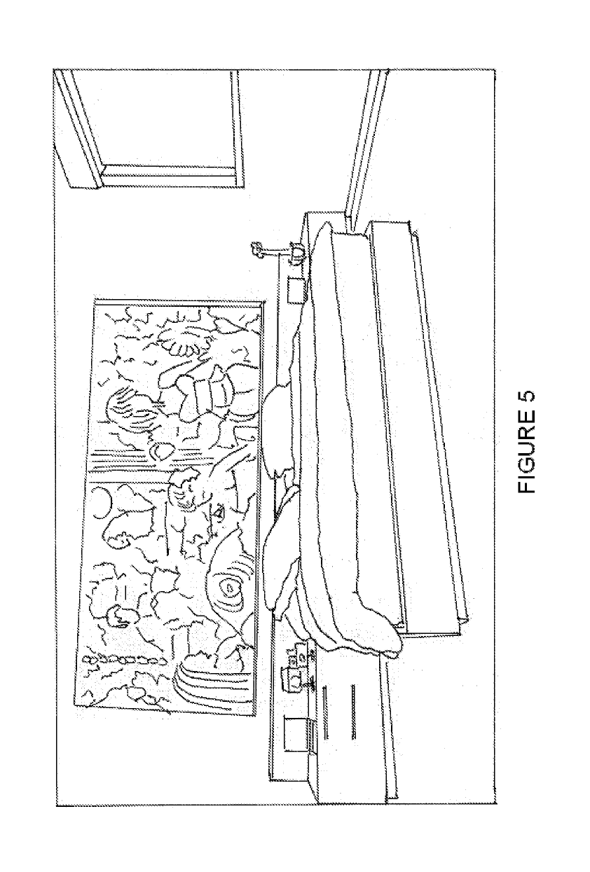

A number of examples of uses of the coating as a decorative coating are shown in FIG. 2, a table top, FIG. 3, a decorative frame for a mirror or window, FIG. 4, side panels for a table, and FIG. 5, a mural in a bedroom.

The method, according to one embodiment of the invention, for providing a coated substrate is as follows. A substrate is selected, cleaned and dried. Preferably, the surface is prepared with a primer, for example, consisting of a layer of moisture resistant material. A layer of a coating material including an acrylic adhesive is spread on the selected substrate. The adhesive layer can be between about 0.5 and about 4 mm in thickness, preferably about 2-3 mm in thickness. If desired, one or more pigments can be mixed into the adhesive before spreading it on the substrate. The applied layer is now cured at room temperature. Once cured, the surface is polished to a smooth outer surface and, preferably, a water-based acrylic lacquer outer layer is applied to the adhesive. The finished product can be cut, like tiles, for use, or formed of modular sheets for combining on site.

According to one embodiment of the invention, the method further includes sponging an outer surface of the adhesive layer with a wet sponge at the beginning of curing. This process causes the formation of a plurality of cracks in the upper surface of the adhesive, providing a veined or marbleized look to the finished surface.

Once cured, the coating can be drawn on, painted on, like any conventional substrate, or can be printed upon, as by conventional machines for printing on rigid materials. The finished product can be framed, like a conventional painting, mounted in furniture or hung on a wall, decorated to produce a decorative object, or put to any other desired use.

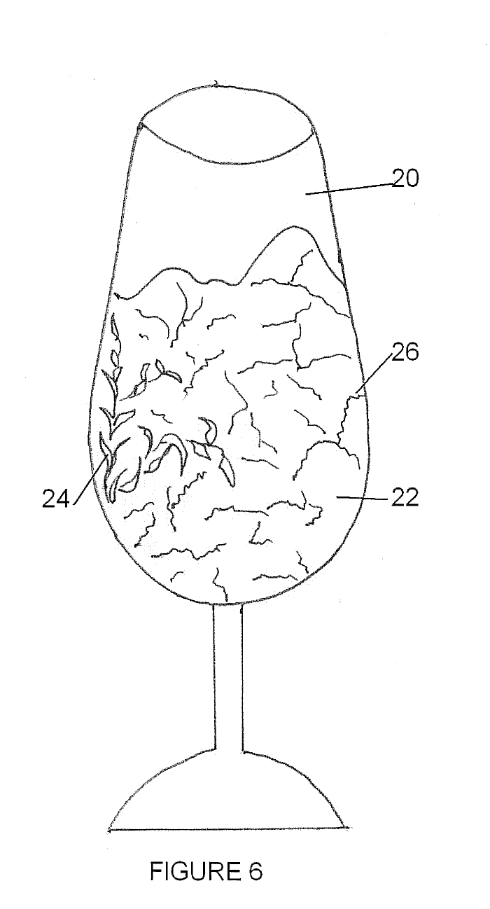

FIG. 6 is a schematic illustration of a curved substrate 20 with a coating 22 according to another embodiment of the invention. As can be seen, an illustration 24 of any sort can be painted on the outside of the coating 22, which is then preferably coated with transparent lacquer or other transparent coating. It will be appreciated that the technique of causing cracks 26 can also be utilized when coating a substrate of any shape or form.

According to various embodiments of the invention, the coated substrate can be made in different forms. The acrylic adhesive can be coated on a lattice or mesh substrate formed, for example, of PVC, aluminum, metal or other suitable material, for use as polymeric cladding for coupling to a moisture-sensitive material or any other material. It will be appreciated that the lattice serves also as reinforcement for the finished cladding. According to a preferred embodiment, the acrylic adhesive is coated on a rigid thermoplastic material to form tiles or other types of panels useful as thermally insulating, and possibly fire proof, cladding. It can be formed as a ribbon, for mounting to seal the gap between adjacent panels, or it can be shaped as a baseboard for mounting on a wall abutting the floor. In short, the products of the present invention can be formed in a variety of different forms, depending on the particular substrate, and the dimensions of the desired unit.

These units can be formed in two main fashions—as cladding or as panels. Polymeric claddings are particularly useful for covering materials that are sensitive to moisture and water. The claddings are prepared separately, either to size or cut to size, and then affixed to the material to be covered. Panels, on the other hand, can be made in any of a variety of different sizes and shapes, and can be formed of thermoplastic substrate materials to form light weight, thermal insulation panels, and other cladding elements for mounting as the outer envelope of a building or on other parts of a structure. When basalt insulation material, made of mineral wool, is utilized as the substrate, the resulting panels provide protection against fire, as well as thermal insulation. The substrate can be provided with a plurality of throughgoing holes, if it is desired to provide acoustic insulation, as well. The cladding panels can be mounted in any conventional manner, as by screwing onto a metal construction on the building structure, or by hanging a pin in a hole on a metal mount, or by means of a polymeric adhesive used for conventional cladding. Yet another option is to hang the panels about 10 cm away from the outer wall of a building, so as to provide shade to that portion of the building. In this case, the outer surface can be printed with a decorative picture or with advertising material for viewing from outside the building.

One preferred method of forming claddings is as follows. A solution of a composition of selected acrylic adhesive polymers is pressed onto a lattice of polyester, aluminum, or any other material meeting local building standards, in a mold whose depth is between about 2 mm and 5 mm. If desired, various color pigments can be added to the composition to provide a tinted or colored cladding, or other additives to impart additional desired characteristics to the finished product. Once the mold is filled, it is leveled. Now, a wet sponge, soaked with water, is gently smoothed over the upper surface of the solution in the mold, along the length and width of the mold, and in circular motions, as desired.

The cladding now undergoes the first stage of drying. First, it is dried in the shade, protected from dust, for about 24 hours. During this time, cracks appear in the surface of the cladding. Now, the cladding is taken out of doors and is dried in sunlight (or the equivalent). After about 48 hours, XX the cladding is leveled and smoothed. Preferably, a grinding machine is used, having three levels of grinding—rough, medium and fine, depending on the finish desired for the final product. If not polished at all, the cured adhesive looks like stone. If the top surface is polished, a layered product will result, having a flattened, polished top surface, and rough surfaces in the cracks. According to one preferred embodiment, the cladding is ground and polished to a smooth, glossy, veined, marble-like finish. It is even possible to grind the adhesive so as to substantially remove all the cracks.

In order to provide a hard, rock-like panel, once the cladding has been smoothed, it is moved to a kiln, where it is moved over heating units at a temperature between about 200° C. and about 300° C., depending on the thickness of the cladding, for about 20 to about 30 minutes. It will be appreciated that claddings that are baked in a kiln need not be dried in the sun first, but can be moved directly to the kiln after the cracks have formed. The baked claddings are sorted according to final use, some for printing on, some for use as floor tiles, some for adhering to plasterboard or wood panels, MDF panels, or other materials that are sensitive to water, so the acrylic could not have been applied directly thereto. It will be appreciated that the claddings can be of any desired shape, size and thickness.

The finished cladding and/or the panel to which is it affixed is preferably coated with a clear protective coating. This coating can be polyurea, polyurethane, an epoxy adhesive, transparent lacquer, or any other suitable coating that will adhere to the cured acrylic adhesive and protect its outer surface.

One preferred method of forming panels for use as thermally insulating building elements is as follows. A rigid thermoplastic material is selected as a substrate. This material can be, for example, expanded polystyrene foam (EPS), polyphan panels (such as marketed by Polybid Ltd., Kibbutz Mishmar Hanegev, Israel), basalt insulation material (such as that marketed by Paz-Insulation Materials Ltd., Kiryat Gat, Israel) (which is also fire resistant), or any other material which does not absorb water. A solution of a composition of selected acrylic adhesive polymers is cast directly onto the substrate material, with or without lattice (typically, polyester or metal), without the need to glue or affix it to the substrate. When utilizing these substrates, the method is substantially the same as described above for cladding, except that the panels are not fired in the kiln. The thermoplastic panels are preferably of a thickness between about 2 cm and about 50 cm, or more, and can be of any desired size.

It will be appreciated that cladding formed as above can be affixed to thermal insulation elements, such as light, rigid thermoplastic panels, to provide substantially the same result as casting the acrylic adhesive directly onto a thermoplastic substrate.

While the cracks provide a marbleized effect in the finished product, it will be appreciated that, alternatively, polymeric cladding or panels can be provided which have no cracks. In order to produce this effect, the cladding or panel is heated to a relatively high temperature immediately after casting, without sitting in the shade for 24 hours. This rapid heating prevents the formation of most of the cracks, and those which do form can be removed by polishing.

It is a particular feature of the invention that the cladding and panels can be utilized as substrates for printing on. Thus, the cladding or panel with the dried acrylic adhesive can be passed through a printing machine, and any desired image can be printed thereon. The clear protective coating is preferably applied after printing, to protect the image.

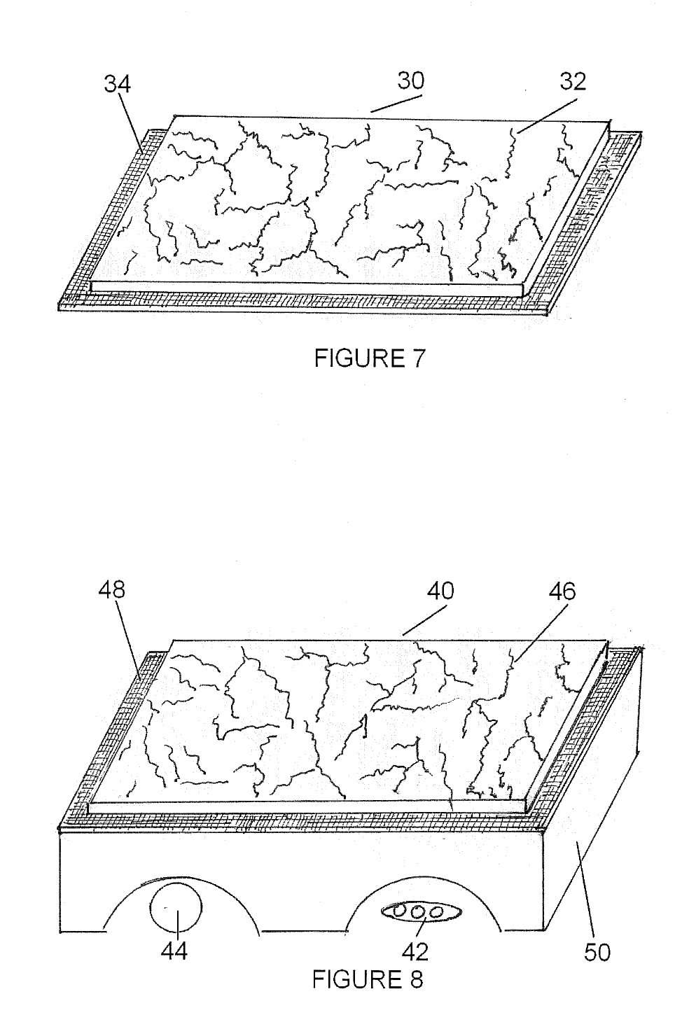

FIG. 7 illustrates an exploded view of a ribbon 30 of coated substrate for closing the gap between adjacent tiles. Preferably, ribbon 30 is formed of a layer 32 of acrylic adhesive cast on a reinforcing lattice 34. Ribbon 30 can be cast in this shape, or can be cut from a larger panel of coated substrate, as by a diamond cutting disc, as used on conventional marble or stone.

Another use of the panels or cladding units of the invention is as decorative tiles for mounting on walls or floors, or as decorative tiles having additional functions. FIG. 8 illustrates a tile 40 of coated substrate for use, for example, to build ducts for holding electric cables 42 or flexible pipes 44. In the illustrated embodiment, tile 40 is formed of a layer 46 of acrylic adhesive cast on a reinforcing lattice 48 on a rigid thermoplastic substrate 50, such as EPS. These tiles 40 permit rapid and easy building of such a duct, without requiring the formation of grooves in walls of the building, and can be easily removed in case of need, for replacement or fixing of pipes in the ducts.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method for providing a coated substrate, the method comprising:
spreading a layer of an x-linked, water-based acrylic adhesive having self-cross linked polymer binder, on a substrate;
curing said acrylic adhesive to provide a coating affixed to the substrate; and
sponging an outer surface of the acrylic adhesive with a wet sponge soaked with water, before curing, so as to cause formation of a plurality of surface cracks in the acrylic adhesive during curing.

2. The method according to claim 1, wherein said step of sponging includes sponging along a length and/or width of the surface of the layer of acrylic adhesive.

3. The method according to claim 1, wherein said step of sponging includes sponging in circular motions on the surface of the layer of acrylic adhesive.

4. The method according to claim 1, further comprising applying a water-based outer protective layer to said cured adhesive.

5. The method according to claim 3, wherein said outer protective layer is selected from the group including an acrylic varnish, transparent lacquer, polyurea, polyurethane and epoxy.

6. The method according to claim 1, wherein said substrate is selected from the group including a screen, a lattice, wood, Styrofoam, aluminum, plasterboard, glass, plastic, ceramic, basalt insulation material.

7. The method according to claim 1, further comprising painting or printing on said cured adhesive layer.

8. The method according to claim 1, wherein:
said step of spreading includes casting said acrylic adhesive on a lattice on the substrate; and
said step of curing includes:
drying said acrylic adhesive at room temperature for about 24 hours; and
further drying said acrylic adhesive at higher than room temperature.

9. The method according to claim 1, wherein said substrate is a light weight, rigid thermoplastic material.

10. The method according to claim 1, further comprising polishing said cured adhesive.

11. The method according to claim 1, further comprising mixing at least one pigment into said adhesive before the step of spreading.

12. The method according to claim 1, wherein said coated substrate comprises a form selected from the group including: panels, ribbons, tiles, cladding, coated thermoplastic insulation panels.

13. The method according to claim 1, wherein said substrate includes a screen or lattice on an insulation material.

14. The method according to claim 13, further comprising applying a water-based outer protective layer to said cured adhesive.

15. The method according to claim 13, further comprising painting or printing on said cured adhesive layer.
